(19) United States
(12) Patent Application Publication
(10) Pub. No.: US 2006/0116888 A1
(43) Pub. Date: Jun. 1, 2006

(54) Method and device for the transmission of notifications

(75) Inventors: Boris Mayer, Bonn (DE); Barbara Buesch, Asbach (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post AG, Bonn (DE)

(21) Appl. No.: 10/524,637

(22) PCT Filed: Aug. 15, 2003
(86) PCT No.: PCT/DE03/02666

§ 371 Date: Feb. 16, 2005

(30) Foreign Application Priority Data
Aug. 16, 2002 (DE) 102 38 345.6

(51) Int. Cl. G06Q 99/00

(52) U.S. Cl. 705/1

(57) ABSTRACT

The disclosure relates to a method for the transmission of notifications wherein data from at least one data bank are transmitted to a central dispatch center, converted there into notification information, and the notification information transmitted to a communication interface and from the communication interface onto one or several receiver devices. The disclosure further relates to a logistic system suitable for application to the method.

The invention relates to a method and to a device for the transmission of notifications.

The invention especially relates to a method and to a device to inform senders or recipients of mailpieces about the status of the shipment.

A method of the generic type is disclosed in French Patent FR 2 563 987. With this prior-art method, information about the filling status of an electronic parcel compartment system is stored in a database of a server and can be retrieved from there.

Another notification method of the generic type is known from U.S. Pat. No. 5,790,974. With this method, two separate databases, each containing calendar information, are connected to each other and each contain software agents that allow a data comparison between the databases.

Another method of the generic type is known from U.S. Pat. No. 6,064,976. This method checks whether a user is present in a predetermined area. If the user is present in the area, then the actual arrival time of the user and an estimated arrival time of the user are compared to each other.

The invention is based on the objective of developing a method of the generic type that allows the most reliable and quickest possible individual notification of users.

In particular, the invention should be suitable for the transmission of individual notifications to numerous users.

According to the invention, this objective is achieved in that a method of the generic type is carried out in such a way that data from at least one database is transmitted to a central sending component (ZVK), where it is converted into notification information, and in that the notification information is transmitted to a communication interface and from the communication interface to one or more receiving devices.

An especially preferred embodiment of the invention is characterized in that, using at least one template, the central sending component converts the data transmitted from the database into the notification information. The template is created, for example, on the basis of XSL:FO (eXtensible Stylesheet Language Formatting Objects). It is especially advantageous to add data to a template.

It is especially advantageous for a control circuit to control the transmission of notification information.

The job requests for the transmission of notifications are transmitted at least partially by a control circuit.

Here, it is especially advantageous for at least some of the requests for the transmission of notifications to be transmitted by the control circuit directly to the central sending component.

In order to allow a notification of users at prescribed times and/or to utilize data transmission capacities more efficiently, it is advantageous for at least some of the requests for the transmission of notifications to be transmitted by the control circuit to a storage module that serves to store notification requests.

An especially advantageous variant of this embodiment is characterized in that a reading module acquires the notification jobs contained in the storage module and transmits them to the central sending component.

Moreover, it is advantageous for information for creating jobs to be transmitted via an external interface.

In this manner, it is possible to enter externally determined values and thus to control the sending of messages.

Such an integration of externally transmitted information is advantageous especially when the invention is used in a shipping logistic system. In this manner, information that is relevant for the logistic process, especially about the arrival of shipments, for example, mailpieces, at prescribed destinations, can be acquired and integrated into the notification system.

An especially preferred application case in this context is the use of the notification component within a postal shipping system. For example, when a mailpiece is dropped off in a compartment of an electronic parcel compartment system, information is automatically transmitted to the external interface. The external interface forwards this information. This information, or a request derived from it to transmit a message, is forwarded to one or more recipients.

It is especially advantageous for information used to create jobs to be transmitted via an external interface.

Here, it is especially advantageous to carry out the method in such a way that the information for creating jobs is transmitted from the external interface to the control circuit.

Moreover, the invention comprises a logistic system with at least one means to transmit notifications to users of the logistic system.

This logistic system is characterized in that the means for the transmission of the notifications is configured in such a way that it can cooperate with at least one database (KT, PD, AD) and with a central sending component (ZVK), in that the central sending component (ZVK) is configured in such a way that it can convert data from the database (KT, PD, AD) into notification information (BI), and in that the central sending component (ZVK) is connected to a communication interface for the transmission of the notification information (BI) to receiving devices.

Additional advantages, special features and practical refinements of the invention ensue from the subordinate claims and from the presentation below of preferred embodiments making reference to the drawings.

The drawings show the following:

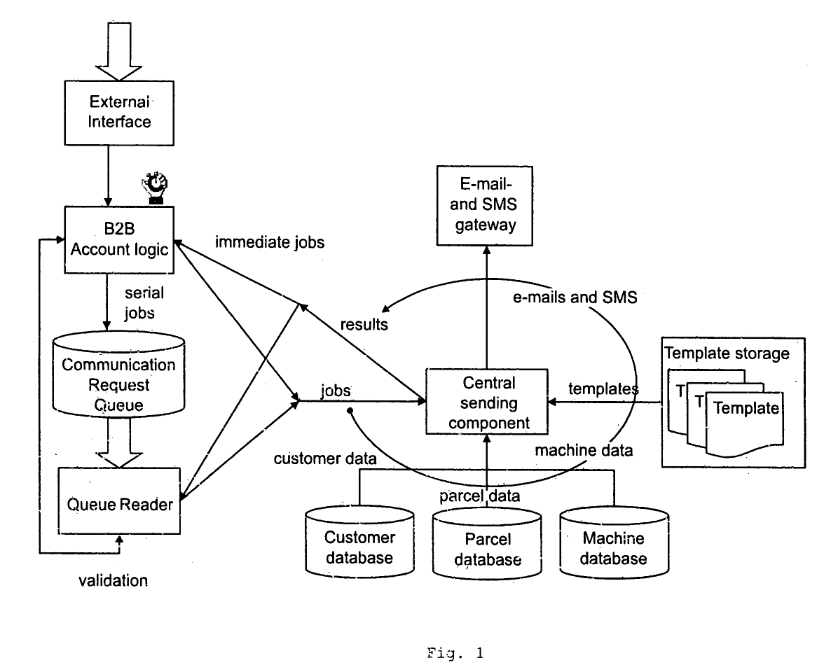

FIG. 1 component view of the notification system,

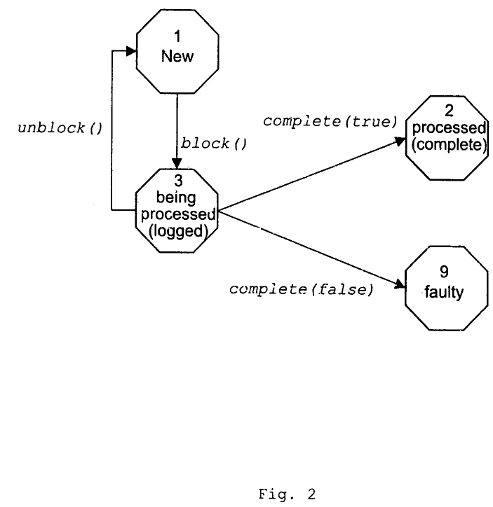

FIG. 2 status diagram for requests to transmit messages,

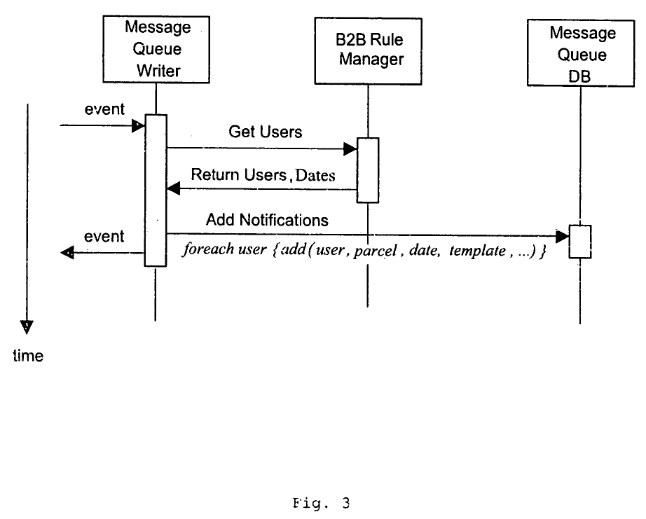

FIG. 3 sequence diagram I—new event

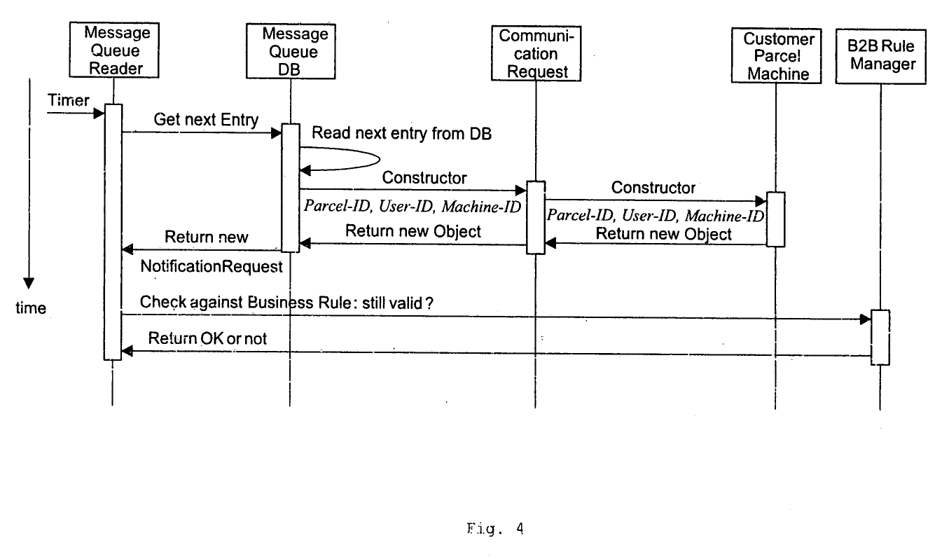

FIG. 4 sequence diagram II—reading out the pending notifications

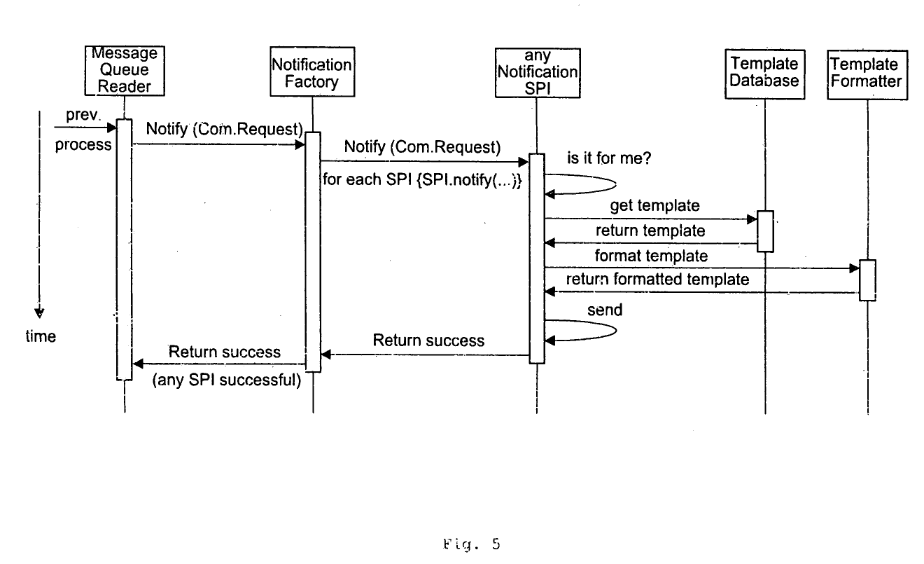

FIG. 5 sequence diagram III—sending the notification

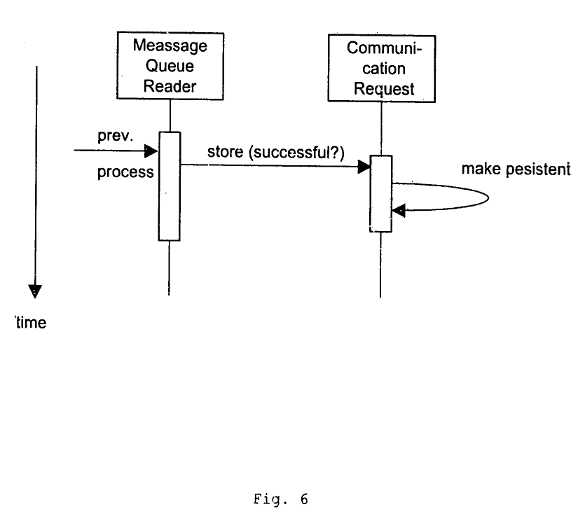

FIG. 6 sequence diagram IV—storing the result.

The use of the methods and devices for notification according to the invention will be described below.

The presented notification components are shown with reference to the example of the notification of users of a logistic system, especially of a transportation system for mailpieces.

The invention is limited neither to the depicted embodiments nor to the use in a logistic system. However, it is especially advantageous to equip a logistic system with the notification components described.

FIG. 1 shows constituents of a notification component that is integrated into a shipping logistic system.

The notification component comprises an external interface EI for receiving event data ED of the shipping logistic system.

The external interface EI is connected to a control circuit AL. The control circuit AL is equipped with transmission means for the transmission of job requests to the central sending component (ZVK) and to the Communication Request Queue CRC.

The Communication Request Queue CRC is preferably configured as a storage module that serves to store notification jobs. The storage module that serves to store notification jobs is connected to a reading module CR.

The reading module CR is connected to the central sending component (ZVK) via a data line.

The notification component has an external interface into which jobs are entered in a message queue. These jobs are regularly read out in a timer-controlled manner by the central component in order to supplement data from the customer database, parcel database or machine database, and these jobs are converted by means of various templates into a push-oriented means for the transmission of information, for example, an e-mail or SMS, and then sent via a suitable communication interface, preferably an e-mail and SMS gateway.

Externally Retrievable Functions

Database Access

The database is accessed using suitable access means, preferably based on EJB technology via Java Entity Beans.

Here, the access to the databases is transparently encapsulated. A database entry identified via the PRIMARY KEY is read in, by creating the home interface of a bean and by subsequently searching with “ejFindByPrimaryKey”.

The terms customer database, parcel database and machine database are of an abstract nature, the appertaining information relates only to one or more tables within the same database instance. Through the use of the EJB, however, a separation into various instances or even databases can be carried out at a later point in time in a transparent manner.

Communication to the E-Mail/SMS Gateway

The communication between the notification component and the e-mail or SMS gateway is effectuated via the standard Java classes for SMTP communication.

Logging

Errors in sending e-mails or SMSs also have to be logged in an error LOG file. These error LOG files have to be monitored regularly, for example, in order to be able to ascertain the failure of a gateway. If all of the sent notifications are likewise to be logged, then a separate LOG file is used for this purpose so as to simplify the error monitoring.

Design Proposals and Limitations

Database

Existing Databases

In order to achieve a smooth transmission of the notifications, access to the following databases of the logistic system has to be ensured:

Customer database: provides information about a customer, identified by the customer number

Parcel database: provides information about a parcel, identified by the unambiguous parcel number

Machine database: provides information about the location of a machine, identified by the MachineID. This is part of the ParcelID

Communication Request Database

It is advantageous to set up an additional database table to store the notifications that are to be sent. The table also serves as an intermediate storage for the second and third notifications to be sent. The table should only serve to administer the queue; concrete information about parcels and recipients are always read out of the customer database or out of the parcel database.

| | | | |
|---|---|---|---|
| Field | Description | Type | Example |

Internal fields that are needed to effectuate the shipment

| | | | |
|---|---|---|---|
| ID | Unambiguous key for the identification | NUMBER (16) | |
| | of the entries, is generated internally | PRIMARY KEY | |
| InsertDate | Date of the entry into the queue, is | DATE | |
| | generated internally | | |
| CompletionDate | Date of the complete processing | DATE | |
| | (status = 2) or failure (status = 9 | | |
| RetryCount | Number of failed previous attempts | NUMBER (13) | |
| State | Status of the request | NUMBER (3) | 1 = new |
| | | | 2 = processed (complete) |
| | | | 3 = in process (logged) |
| | | | 9 = faulty |
| State | Status of the request | Number (3) | 1 = new |
| | | | 2 = processed (complete) |
| | | | 3 = in process (logged) |
| | | | 9 = faulty |

Externally prescribed fields

| | | | |
|---|---|---|---|
| CommunicationType | Indicates the route of communication | VARCHAR (12) | SMS, PlainText, User (=preferred |
| | | | method stored for the user) |
| | | | (can be augmented by FAX, PAGER, |
| | | | HTMLMail, RFC1149, etc.) |
| SendDate | Date and time of day, after which | DATE | |
| | the sending should take place | | |
| RecipientID | User ID of the recipient | VARCHAR (16) | LP_4711, LC_1234, US_0815 |
| ParcelID | Parcel number (can be blank) | VARCHAR (16) | |
| Template | Name of the template to be used | VARCHAR (12) | BNK1, BNK2, BNK3 |
| Communication flags | Parameters for controlling the | NUMBER (8) | CheckParcel- |
| | shipment, they are set by the B2B | | InMachine |
| | component so that, in case of | | DelaySMSSending |
| | later queries, it is possible to | | |
| | logically follow the decisions | | |
| | made in the Client Logic | | |

Preferred sequence diagrams are depicted below:

FIG. 3 shows a sequence diagram for a new notification event, for example, the placement of a parcel in a compartment of a parcel compartment system.

This event is transmitted to a message generating unit MQW. A request for the transmission of user data is sent by the message generating unit MQW to a database for administering the user data B2BRM. The database for administering the user data B2BRM sends the information about the user and the appertaining data to the message generating unit MQW. This information, together with additional notification information, for example, about the recipient and/or sender of the mailpieces that were placed into the parcel compartments or that can be picked up, is transmitted to a message storage unit MQWB.

The pending notifications can be read out in a push-oriented as well as a pull-oriented manner.

In the following preferred embodiment of the reading out of notifications, the advantages of push-oriented handling of the information to be dealt with are combined with the advantages of pull-oriented handling.

This embodiment provides that the notification is transmitted to the message storage unit on the basis of an event, in an especially preferred embodiment on the basis of a time signal that comes from a timer.

The MQR transmits a request for reading new entries to the message storage unit MQDB. The message storage unit MQP reads the entry information from a database and transmits shipment-specific information, especially an identification number for individual parcel compartments, or else mailpieces placed there (ParcelID), user identification information (UserID) and/or information about the electronic parcel compartment system (MachineID) to a storage module CRC that serves to store notification jobs. The storage module CRC forwards this identification information to suitable recipients, for example, users C of the electronic parcel compartment system, to participants in the logistic system, or to the electronic parcel compartment system.

The named recipients, or data processing units acting on their behalf, send a new data object to the storage module CRC that serves to store notification jobs. The storage module forwards the new object to the message storage unit MQDB. The message storage unit MQDB subsequently sends a new notification request.

Classes

An especially preferred embodiment of the invention is characterized by the use of different classes of notifications. Preferably, a distinction is made between virtual classes and singleton classes.

A message reading unit MQR reads the entries from the message queue, draws up Notification Request Data Container objects and forwards them to the Notification Factory instance.

Message Queue DB

The class serves as an encapsulation of the access to the database table with the message queue. It provides the following methods:

InitReader ( )

GetNextEntry ( )

AddEntry ( )

Notification Request Data Container

The class is a data container for the entries in the message queue and the stored data in the customer database, parcel database and machine database. The class provides Get/Set methods for all of the required fields.

Customer Database

The class serves as an encapsulation of the access to the database table with the customer database. It allows the customer data to be read out on the basis of a CustomerID.

Parcel Database

The class serves as an encapsulation of the access to the database table with the parcel database. It allows the parcel data to be read out on the basis of a ParcelID.

Machine Database

The class serves as an encapsulation of the access to the database table with the machine database. It allows the machine data to be read out on the basis of a Machine ID.

Notification Factory

This class is the central administration of the notification service provider interfaces. This is where a list of all existing notification service provider interfaces is administered.

In addition to functions for the administration of the notification SPIs, it provides the method

bool machet (Notification Request Data Container *)

that sends all of the necessary notifications for a transmitted Notification Request Data Container object. For this purpose, the Notification Request Data Container object is transmitted to all notification SPIs.

Base Notification SPI

This class is the base class for all notification implementations. It provides the

bool machet (Notification Request Data Container *)

method to be overwritten that sends a notification (if this is possible from the transmitted data and if this is desired).

First of all, there will be two implementations for sending PlainText e-mails and for sending SMSs. Additional implementations (for example, for HTML-formatted e-mail, pager, fax, FunCard . . . ) can easily be added.

Plain Text E-Mail Notification SPI

Implementation of the Base Notification SPI for sending plain text e-mails

SMS Notification SPI

Implementation of the Base Notification SPI for sending SMSs

Class Template Database

This class allows access to templates on the basis of several keys.

Overview of member variables and member functions

| | |
|---|---|
| Class name | de.post24.notificationSystem.TemplateDB |
| Inherits from | — |
| Implements | — |
| Public methods | TemplateDB ( ); |
| | String GetTemplate (String class, String type, |
| | String locale, bool usedefault) |

Specification of member variables and member functions

String GetTemplate (String class, String type, String locale, bool usedefault)

Supplies a template corresponding the transmitted parameters

In class indicates the classification of the template (plain text e-mail, SMS)

In type indicates the type of template (registration, change, NewParcel, NewCODParcel)

In locale serves to distinguish among different language and country versions (e.g. “de-DE” (German-Germany) or “en-US” (English-United States)

In usedefault here, it is possible to set whether a default language should be used if the requested language does not exist, or else an empty string

Return the method supplies the appropriate template or else an empty string, if no appropriate template was found

Template Formatter

This class serves to format the template with the data to be transmitted. It provides a method:

String FormatTemplate (String template, Notification Request Data Container *, int maxlen,

String[ ] neededTokens)

All of the placeholders in template are replaced by corresponding values. If the maximum length is set at maxlen, field contents are abbreviated in order not to exceed this maximum length. In neededTokens, a list of placeholders can be transmitted whose existence is checked in the template.

In a logistic system involving a delivery and/or pick-up of parcels in electronic parcel compartment systems, the notification component serves especially to generate and send customer notifications. For this purpose, events such as customer registration, change of customer master data, parcel delivery and pick-up are reported via an interface. On the basis of stored information, the notification component creates one or more push-oriented notifications such as e-mails and/or SMSs and sends them via a suitable, preferably push-oriented interface, for example, an e-mail or SMS gateway. Preferably, the notification component also monitors the parcel pick-up and optionally sends second and third notifications.

The notification component according to the invention is an integral part of a logistic system according to the invention.

The notification component is preferably a modular constituent of the logistic system. Preferably, the notification component contains automated notification procedures that contain at least individual constituents for an automation of the logistic system. Preferably, the entire process of the logistic system is integrated.

Preferably, the notification component is informed externally about events. The events are preferably categorized in different classes and each event triggers previously defined or definable and optionally variable processing steps by the notification component. An example of such an external event is the placement of a parcel into an electronic parcel compartment system that is part of the logistic system.

The notification component ensures the transmission of all notifications. These are the notifications to automated data processing units as well as to recipients. The notification can be sent once or multiple times, so that this automated notification component also allows the automatic sending of reminders.

In the manner described, the notification component allows a refinement of the logistic system, an adaptation to omissions and utilizations of the logistic system and especially an integration of essentially or completely automated components, such as electronic parcel compartment systems, into the logistic system.

### LIST OF REFERENCE NUMERALS

AD database
AL control circuit
BI notification information
CR reading module
CRC storage module
EI external interface
KT database
MQR message reading unit
MQW message generating unit
MQDB message storage unit
PD database
T1 template
T2 template
T3 template
ZVK sending component

1.-9. (canceled)

10. A method for the transmission of notifications by a notification component to users of an electronic parcel compartment system within a postal shipping system, comprising transmitting data from at least one database to a central sending component, converting the data in the central sending unit into notification information, transmitting the notification information to a communication interface and from the communication interface to at least one receiving device, storing notification jobs in a storage module and transmitting at least some of the requests for the transmission of notifications by a control circuit the storage module, and a reading module acquiring the notification jobs contained in the storage module and transmitting them to the central sending component,
the method further comprising transmitting the information for creating jobs is transmitted to the control circuit via an external interface, whereby the information depends on events within the postal shipping system, categorizing the events in classes, and the events triggering defined, definable or variable processing steps by the notification component.

11. The method of claim 10, comprising using at least one template, the central sending component converting the data transmitted from the database into the notification information (BI).

12. A device for the transmission of notifications to users of an electronic parcel compartment system within a postal shipping system having at least one database, one central sending component for converting data from the database into notification information, and one communication interface for the transmission of the notification information to receiving devices,
the device further comprising
an external interface that serves for receiving information about events at an electronic parcel compartment system within the postal shipping system and is connected to a control circuit equipped with transmission means for the transmission of notification job requests to a storage module that stores the notification requests, a storage module (CRC) is connected to a reading unit that transmits the notification jobs to a central sending component.
